(19) United States
(12) Patent Application Publication
(10) Pub. No.: US 2020/0041820 A1
(43) Pub. Date: Feb. 6, 2020

(54) System and method for attaching accessories to eyewear

(71) Applicant: Hannah Lynn Widmer, Minneapolis, MN (US)

(72) Inventor: Hannah Lynn Widmer, Minneapolis, MN (US)

(21) Appl. No.: 16/261,314

(22) Filed: Jan. 29, 2019

Related U.S. Application Data
(60) Provisional application No. 62/713,306, filed on Aug. 1, 2018.

(51) Int. Cl. G02C 11/02

(52) U.S. Cl. CPC G02C 11/02

(57) ABSTRACT

A system and method of securing an accessory to an eyewear frame by providing at least one attachment mechanism comprising dual loops wherein a first loop is configured for connection to the eyewear frame and a second loop is configured for connection to the accessory and sliding the first loop onto an arm of the eyewear frame. One or more accessories each having at least one secondary attachment mechanism for securing to the second loop can be provided and securing the second loop to the at least one secondary attachment mechanism allows for interchangeably securing at least one of the one or more accessories to the eyewear frame. The accessory may be a fabric drape, scarf, hat, headband, necklace, or other adornment configured to be secured to eyewear or otherwise dangle or drape from the eyewear frame.

### CROSS-REFERENCE TO RELATED APPLICATION

The present application is based on and claims the benefit of U.S. provisional patent application Ser. No. 62/713,306, filed Aug. 1, 2018, the content of which is hereby incorporated by reference in its entirety.

### BACKGROUND

Eyewear, such as eye glasses, are not only a required eye sight correction device for many people, but eye glasses have also become a fashion accessory worn with non-corrective lenses. Sunglasses have also become a popular accessory having a fashion and/or ornamental function as well as protecting the wearer's eyes from the sun's rays.

Various accessories have been combined with eyewear in the prior art, including headbands or visors in efforts to prevent a wearer from losing the eyewear when removed. The prior art integrates or combines the headgear accessories with the eyewear in a manner such that the headgear is not easily attachable or removable from the eyewear.

### SUMMARY

An aspect of the present disclosure relates to a method of securing an accessory to an eyewear frame by providing at least one attachment mechanism comprising dual loops wherein a first loop is configured for connection to the eyewear frame and a second loop is configured for connection to the accessory and sliding the first loop onto an arm of the eyewear frame. One or more accessories each having at least one secondary attachment mechanism for securing to the second loop can be provided and securing the second loop to the at least one secondary attachment mechanism allows for interchangeably securing at least one of the one or more accessories to the eyewear frame.

The attachment mechanism may be comprised of rubber, plastic or a combination thereof and may be adjustable with respective to the sizes of the first loop and second loop for securing to the arm of the eyewear frame and accessory respectively.

The accessories may be constructed from fabric. Examples of accessories include but are not limited to a scarf, hat, necklace, dangling adornment, fabric drape or headband.

The secondary attachment mechanism can be fixedly secured to the accessory and comprise a folded over portion of the accessory stitched closed on at least one side and the second loop secured within the folded over portion of the accessory.

Alternatively, or additionally, the secondary attachment mechanism may comprise a moldable component configured to be bent, twisted, folded, rolled or otherwise molded with a first end secured to the second loop of the attachment mechanism and a second end secured to the accessory.

Alternatively, or additionally, the secondary attachment mechanism may comprise a clip or clasp fixedly secured to the accessory and removably connectable with the second loop.

Adjusting respective sizes of the first and second loop for securing the loops to the eyewear and secondary attachment mechanism may be accomplished by moving an adjustment mechanism connecting the first and second loop together.

Another aspect of the present disclosure relates to a system for attaching one or more accessories to an eyewear frame for user wearing. The system comprises a first attachment mechanism comprising a first loop, a second loop, and an adjustment mechanism connecting the first and second loop. The first loop comprises an opening configured to receive a portion of the eyewear frame there through such that the first loop is configured to slide or roll onto a portion of the eyewear frame and wherein the second loop is configured to connection to or with a secondary attachment mechanism. The system further comprises at least one accessory, the accessory comprising at least one secondary attachment mechanism for connection to the second loop of the attachment mechanism for removably connecting the accessory to the eyewear frame.

The secondary attachment mechanism may be sewn to the accessory and the accessory may be constructed from fabric.

The secondary attachment mechanism may alternatively be clipped to the accessory, or tied to the accessory.

In one embodiment, the secondary attachment mechanism comprises a moldable component that can be wound, twisted, folded, rolled or bent such that one end of the moldable component is configured to connect to the accessory and an opposing end of the moldable component is configured to connect to the second loop.

The accessory may be one of a necklace, dangling adornment, fabric drape, scarf, hat, headband or combination thereof.

Further, the attachment mechanism may be removably securable to the eyewear frame and the accessory then removably securable to the attachment mechanism. Alternatively, the attachment mechanism may be removably securable to the eyewear frame and the accessory fixedly secured to the secondary attachment mechanism.

### BRIEF DESCRIPTION OF THE DRAWINGS

FIG. 1 illustrates an attachment mechanism for securing an accessory to eyewear.

FIG. 2 illustrates an attachment mechanism for securing an accessory to eyewear.

FIG. 3 illustrates an attachment mechanism for securing an accessory to eyewear.

### DETAILED DESCRIPTION

A removable attachment mechanism for various accessories wherein the attachment mechanism does not damage or permanently alter the eyewear device is described herein. The eyewear device may be prescription glasses, reading glasses, fashion eyewear, sunglasses or other eyewear having a frame and generally worn by a user. The attachment mechanism is configured for use on any frame configured to be supported on a user by the user's head and/or ears and wrap around a least a portion of the user's face or head. In one embodiment, the eyewear device comprises “temples,” otherwise known as arms or bows that are affixed to the frame front and extend around to behind the wearer's ears.

The removable attachment mechanism described herein is used in connection with a fashionable and/or functional accessory. For example, a method of attaching fashionable and/or functional adornments to eyewear temples is described herein. The adornments can be accessories, including, but not limited to, patches and fabric pieces.

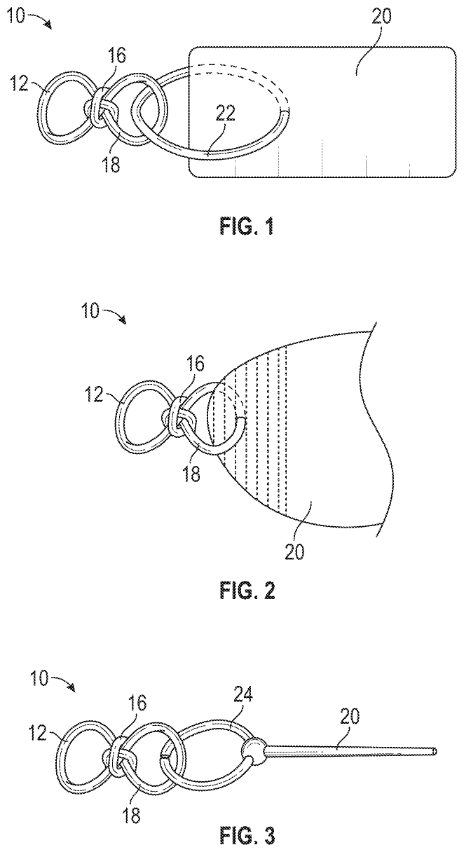

The adornments or accessories are attached to the eyewear frame by an attachment mechanism 10 illustrated in FIGS. 1-7. The attachment mechanism 10 is configured for removable attachment to eyewear and concurrently attaching to an accessory 20 such that the accessory is removably securable to the eyewear. The attachment mechanism 10 may be either removably or fixedly secured to the accessory 20.

As illustrated in the figures, the attachment mechanism 10 comprises one or more attachment points 12, 14. The attachment points may be, for example, loops or hooks. In one embodiment, the attachment mechanism 10 is a double loop 12, 14 device for concurrent securing to the eyewear and to the accessory 20. The mechanism 10 may take the form of a figure-eight for example. A connector or adjustment mechanism 16 may be positioned to secure the hooks 12, 14 together and can be used adjust the respective sizes of the loops 12, 14 respectively ensuring a fit between a first hook 12 and an arm of the eyewear and a second hook 14 and the accessory 20.

The accessories 20 are configured for connection to the attachment mechanism 10 which is an adjustable device, in various ways. For example, fabric accessories may be secured to and held by one loop 14 of the mechanism 10 by threading a length of the fabric of the accessory 20 through one side of the figure-eight and stitching the fabric down the other side. That is, a connection point 22 is formed on the accessory 20 via sewing or stitching a folded over opening on the fabric to securely receive the second loop 14 therein. Additional or alternative accessories 20 (including those resembling hats) the connection point 22 may be formed by threading a thin, moldable component through one loop of the attachment mechanism 10 and securing the moldable component by rotating, twisting, bending, or tying the moldable component to the opposite side of the accessory 20. This component may be, but is not limited to, a formable wire and/or rope, or string. Another connection point 22 may comprise a clip secured to the accessory and the clip configured for removable connection with one loop of the attachment mechanism 10. The clip may be a jewelry clasp. This allows the wearer to disengage the eyewear attachment point of the attachment mechanism for dual use of the accessory secured by this style connection point 22 into a regular accessory that can be worn around the neck, arm or ankle.

The attachment mechanism 10 described herein allows a wearer to removably secure or attach various fashion and/or functional accessories to eyewear and interchange the accessories as selected.

A wearer can connect the attachment mechanism 10 described herein to the temple of selected eyewear (otherwise called an arm or bow). The attachment mechanism is comprised of rubber or plastic, or a similar flexible and substantially smooth surface that provides frictional engagement with the temple or arm of the eyewear connected thereto. In the embodiment illustrated, the attachment mechanism is a small rubber or plastic double sided loop or figure eight construction wherein the temple or arm of the eyewear is inserted through one loop of the mechanism for connection.

The accessories 20 described herein are connected to the eyewear by attaching or securing the connection point 22 of the accessory 20 to one loop of the attachment mechanism 10 as described in further detail above and by attaching the opposing loop of the attachment mechanism 10 to the eyewear.

Multiple attachment mechanisms 10 can be provided, for example, the attachment mechanisms can be provided in pairs. Thus, one accessory 20 can be secured to one pair of eyewear, such as at or to both arms or bows of the eye wear. Additionally or alternatively, multiple accessories 20 may be attached to the eyewear via a plurality of attachment mechanisms 10.

In one embodiment the accessory 20 is a scarf, headband, neck wrap, hair wrap or similar accessory comprised of fabric and said accessory is attached to eyewear via a pair of attachment mechanisms 10. A first attachment mechanism 10 is secured to a first end of the accessory 20 and a second attachment mechanism 10 is secured to an opposing end of the accessory 20. The attachment mechanisms 10 may then be fixedly secured or removably secured to one or more locations on the accessory 20. The attachment mechanisms 10 may be secured to the accessory 20 via any one more embodiments described herein. Thus, the accessory 20 is secured around the wearer's head and/or neck and may drape from the wearer's ears (via connection to the eyewear) to cover the wearer's front, back, neck or otherwise serve as an article clothing or fashion accessory. The attachment mechanism 10 can be used in connection with additional attachment mechanisms 10 in order to secure various accessories to one or both arms or bows of the eyewear.

The accessories described herein can be made of fabric, paper, plastic, or any blend of materials that can be affixed as described above. The measurements and dimensions vary depending on the selected accessory. These may represent, but are not limited to a hat, scarf, cape, fabric drape or headband. These accessories may be modified using elastic, adorned with ornamentation and/or additional fabrics. The accessories may be fashion accessories and/or functional accessories.

The attachment mechanism may be sold as a kit comprising one or more attachment mechanisms and one or more accessories having the secondary attachment surface secured thereon.

The attachment mechanism may be sold as a kit comprising one or more primary attachment mechanisms and the secondary attachment mechanism configured for attaching to a pre-existing accessory for securing the accessory to the eyewear.

Although the present disclosure has been described with reference to preferred embodiments, workers skilled in the art will recognize that changes may be made in form and detail without departing from the spirit and scope of the disclosure.

1. A method of securing an accessory to an eyewear frame comprising:
providing at least one attachment mechanism comprising dual loops wherein a first loop is configured for connection to the eyewear frame and a second loop is configured for connection to the accessory;
sliding the first loop onto an arm of the eyewear frame;
providing one or more accessories each having at least one secondary attachment mechanism for securing to the second loop; and
securing the second loop to the at least one secondary attachment mechanism for interchangeably securing at least one of the one or more accessories to the eyewear frame.

2. The method of claim 1 wherein the attachment mechanism is comprised of rubber, plastic or a combination thereof.

3. The method of claim 1 and further comprising adjusting respective sizes of the first loop and second loop for securing to the arm of the eyewear frame and accessory respectively.

4. The method of claim 1 wherein the accessories are constructed from fabric.

5. The method of claim 1 wherein the accessories include one or more of a scarf, hat, necklace, dangling adornment, fabric drape or headband.

6. The method of claim 1 wherein the secondary attachment mechanism is fixedly secured to the accessory and comprises a folded over portion of the accessory stitched closed on at least one side and the second loop secured within the folded over portion of the accessory.

7. The method of claim 1 wherein the secondary attachment mechanism comprises a moldable component configured to be bent, twisted, folded, rolled or otherwise molded with a first end secured to the second loop of the attachment mechanism and a second end secured to the accessory.

8. The method of claim 1 wherein the secondary attachment mechanism comprises a clip or clasp fixedly secured to the accessory and removably connectable with the second loop.

9. The method of claim 1 and further adjusting respective sizes of the first and second loop for securing the loops to the eyewear and secondary attachment mechanism by moving an adjustment mechanism connecting the first and second loop together.

10. A system for attaching one or more accessories to an eyewear frame for user wearing, the system comprising:
A first attachment mechanism comprising a first loop, a second loop, and an adjustment mechanism connecting the first and second loop;
wherein the first loop comprises an opening configured to receive a portion of the eyewear frame there through such that the first loop is configured to slide or roll onto a portion of the eyewear frame and wherein the second loop is configured to connection to or with a secondary attachment mechanism; and
at least one accessory, the accessory comprising at least one secondary attachment mechanism for connection to the second loop of the attachment mechanism for removably connecting the accessory to the eyewear frame.

11. The system of claim 10 wherein the secondary attachment mechanism is sewn to the accessory.

12. The system of claim 11 wherein the accessory is constructed from fabric.

13. The system of claim 10 wherein the secondary attachment mechanism is clipped to the accessory.

14. The system of claim 10 wherein the secondary attachment mechanism is tied to the accessory.

15. The system of claim 10 wherein the secondary attachment mechanism comprises a moldable component that can be wound, twisted, folded, rolled or bent such that one end of the moldable component is configured to connect to the accessory and an opposing end of the moldable component is configured to connect to the second loop.

16. The system of claim 10 wherein the accessory is one of a necklace, dangling adornment, fabric drape, scarf, hat, headband or combination thereof.

17. The system of claim 10 wherein the attachment mechanism is removably securable to the eyewear frame and wherein the accessory is removably securable to the attachment mechanism.

18. The system of claim 10 wherein the attachment mechanism is removably securable to the eyewear frame and wherein the accessory is fixedly secured to the secondary attachment mechanism.
